(19) United States
(12) Patent Application Publication
(10) Pub. No.: US 2012/0315789 A1
(43) Pub. Date: Dec. 13, 2012

(54) Quick Connect System For A Fan Light Kit

(76) Inventor: Jack R. Kerr, JR., Hearne, TX (US)

(21) Appl. No.: 13/462,786

(22) Filed: May 2, 2012

Related U.S. Application Data
(60) Provisional application No. 61/481,716, filed on May 2, 2011.

(51) Int. Cl. H01R 13/66

(52) U.S. Cl. 439/536

(57) ABSTRACT

A quick connect fixture system for an electrical box. The system includes an electrical fixture having a plurality of fixture wires and an electrical box affixed to a structure. The electrical box has an enclosure housing a plurality of structure wires connected to a power source. The electrical box includes a cap having an orifice leading to the structure wires located in the enclosure. In addition, the orifice includes a plurality slots. The system also includes a removable cover covering the orifice and having a plurality of prongs sized and shaped to be removably attached to leads of the structure wires. The system also includes an adapter ring attachable to a shaft of the electrical fixture.

### RELATED APPLICATIONS

This utility application claims the benefit of U.S. Provisional Patent Application Ser. No. 61/481,716 filed May 2, 2011 by Jack R. Kerr, which is hereby incorporated by reference.

### BACKGROUND OF THE INVENTION

1. Field of the Invention

This invention relates to light fixtures. Specifically, and not by way of limitation, the present invention relates to a quick connect system for a fan light kit.

2. Description of the Related Art

Many houses and buildings have electrical boxes mounted in the walls or ceilings. These electrical boxes provide support and storage of various wiring devices, lighting fixtures, fans, and many other devices useful in a building. Electrical boxes also provide a space for electrical connections between the wiring device or fixture and the wiring of the building. These electrical boxes are normally attached to one or more structural supports, such as joists or studs. Often the electrical boxes include brackets for directly attaching the electrical box to the support member, while other electrical boxes are attached to a hanger or other support assembly which extends between a pair of adjacent structural supports.

The electrical boxes typically allow some connection to a light or fan fixture supported below the electrical boxes. Electrical wires housed in the electrical box are connected to corresponding wires of the light fixture. The actual step of connecting the wires together is quite simple. However, the process of lifting the light fixture up above the installer, threading the wires through the electrical box, connecting the wires with the light fixture wires and the mounting of the light fixture is very cumbersome in existing systems.

FIG. 1 is a top view illustrating a mounting assembly 10 and attached electrical box 12 in an existing system. FIG. 2 is a front view illustrating a cap 14 removed from an enclosure 16 having interior wires 18 leading from the house or building to a light or fan fixture. The cap includes an orifice 20 covered by a cover 22. The cap is affixed to the enclosure by screws (not shown) which attach through a perimeter at 30, 32, and 34 into an edge 40 of the enclosure. The installer must remove the screws from the cap and enclosure and remove the cap to access the wires 18. The wires are then thread through the orifice 20. The cap is then reattached to the enclosure by inserting screws at 30, 32 and 34. Because of the position of the mounting assembly 10 and electrical box 12 above the installer's head, the task of removing the cap, retrieving the wires, connecting the wires to the fixture and reattaching the cap to the electrical box is both tedious and cumbersome.

Therefore, it would be advantageous to have a quick connect system for connecting wires stored in an electrical box with a light fixture. It is an object of the present invention to provide such an apparatus.

### SUMMARY OF THE INVENTION

In one aspect, the present invention is a quick connect fixture system. The system includes an electrical fixture having a plurality of fixture wires and an electrical box affixed to a structure. The electrical box has an enclosure housing a plurality of structure wires connected to a power source. The electrical box includes a cap having an orifice leading to the structure wires located in the enclosure. In addition, the orifice includes a plurality slots. The system also includes a removable cover covering the orifice and having a plurality of prongs sized and shaped to be removably attached to leads of the structure wires. The system also includes an adapter ring attachable to a shaft of the electrical fixture. The adapter ring is sized and shaped to fit within the orifice. In addition, the adapter ring includes extensions corresponding to the slots of the orifice. The cover is removed from the orifice allowing the structure wires within the enclosure to be pulled through the orifice without removing a cap covering a bottom portion of the electrical box. The adapter ring, upon passing through the orifice, is retained against the cap by twisting the adapter ring to move the extensions away from the slots.

### BRIEF DESCRIPTION OF THE DRAWINGS

FIG. 1 (prior art) is a top view illustrating a mounting assembly and attached electrical box in an existing system;

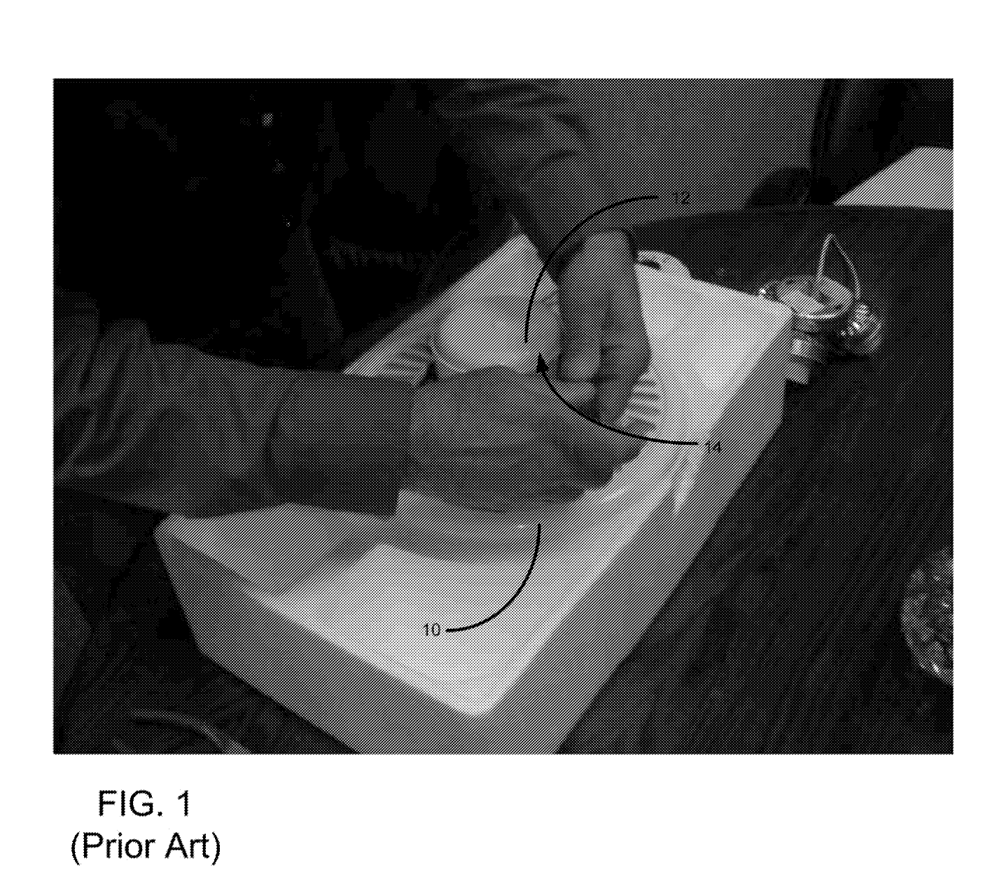

FIG. 2 (prior art) is a front view illustrating a cap removed from an enclosure;

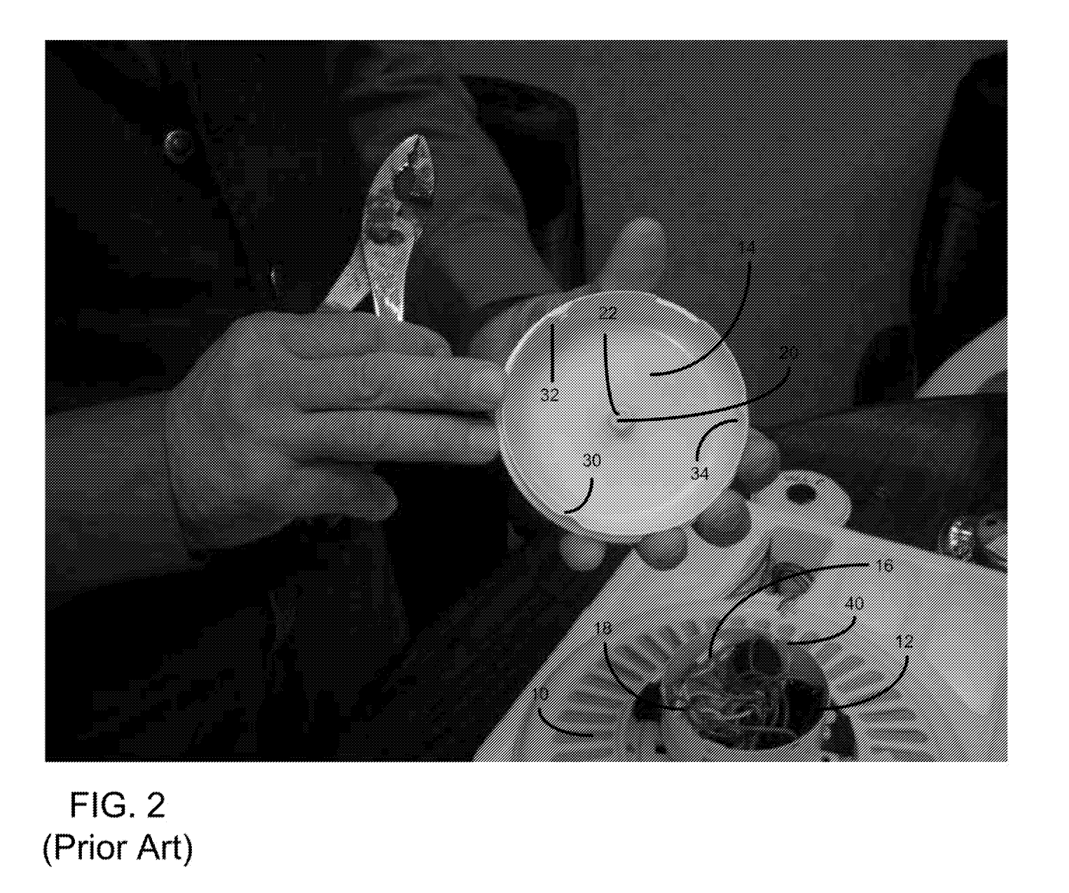

FIG. 3 is a top view illustrating an electrical box mounted to a mounting assembly;

FIG. 4 is a bottom view of the cap and leads removed from the wires;

FIG. 5 is a top view of the adapter ring;

FIG. 6 is a side view of the adapter ring;

FIG. 7 is a top view of a light fixture;

FIG. 8 is a top view of the removable cover being pulled from the cap;

FIG. 9 is a top view illustrating the cover removed from the leads;

FIG. 10 is a top view of the wires connected to the leads prior to insertion through the orifice;

FIG. 11 is a top view showing the leads being inserted in the enclosure; and

FIG. 12 is a side view of the light fixture mounted to the mounting assembly.

### DESCRIPTION OF THE INVENTION

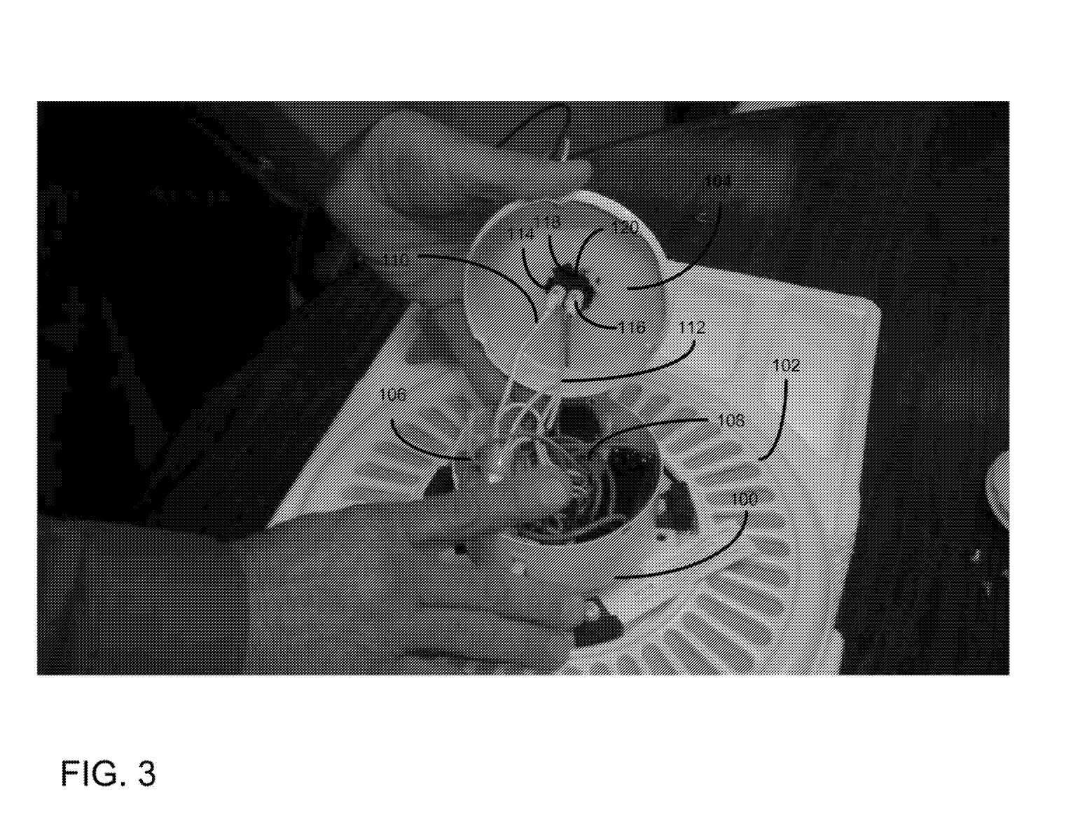

The present invention is a quick connection system for connecting an electrical box with a light fixture. FIG. 3 is a top view illustrating an electrical box 100 mounted to a mounting assembly 102. The electrical box includes a cap 104 and an enclosure 106 housing a plurality of wires 108. Two wires 110 and 112 have leads 114 and 116 which are attached to a removable cover 118 covering an orifice 120 of the cap 104. The cap is attached to the enclosure in the same fashion as prior art electrical boxes where screws are fastened to the sides of the cap and rim of the enclosure.

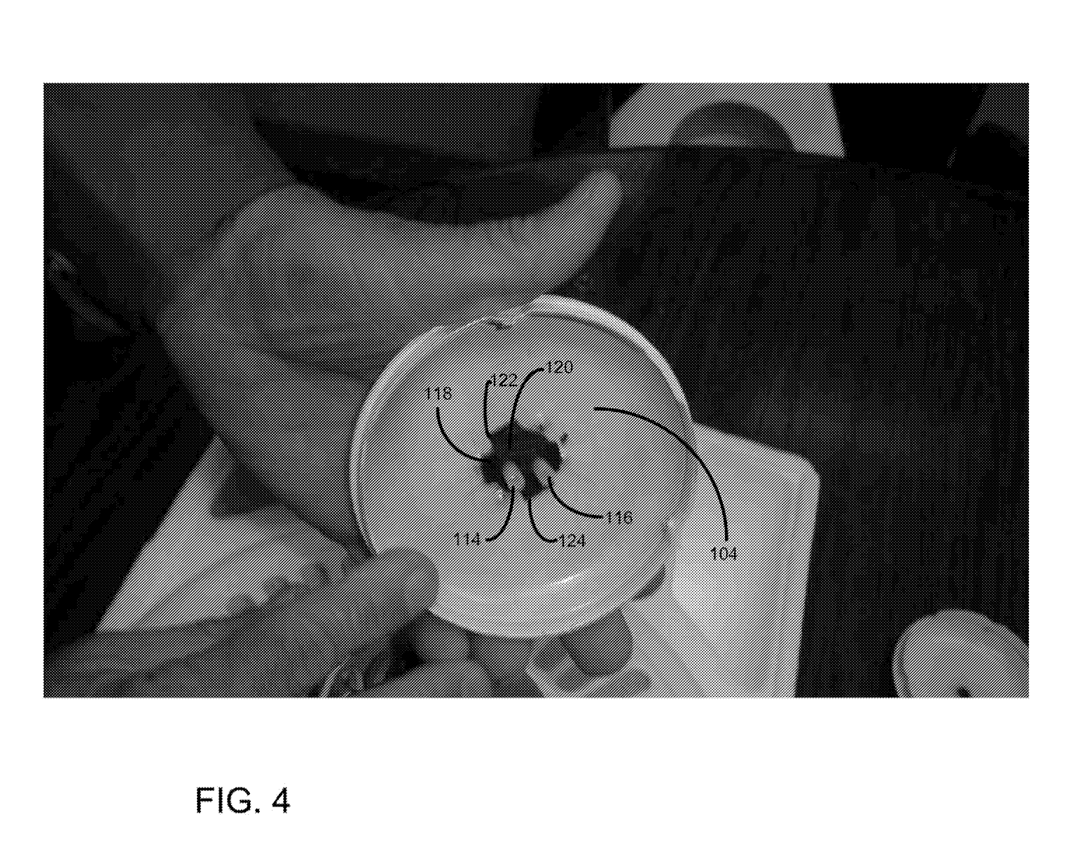

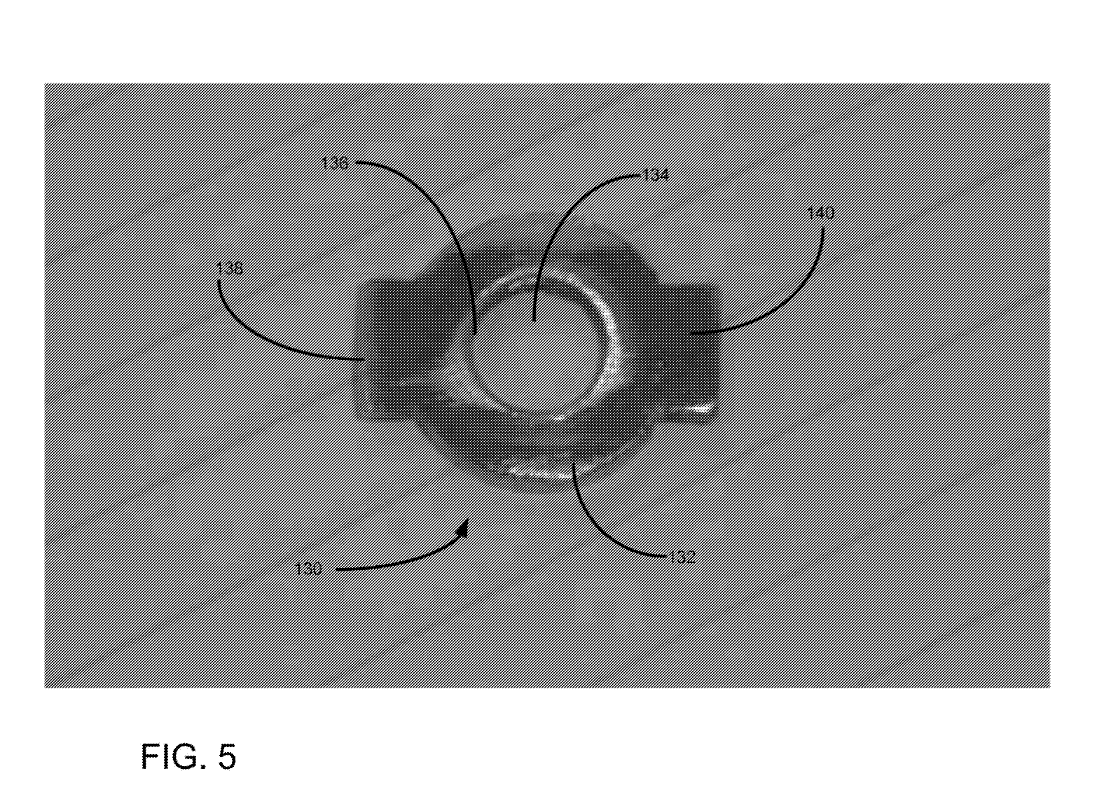

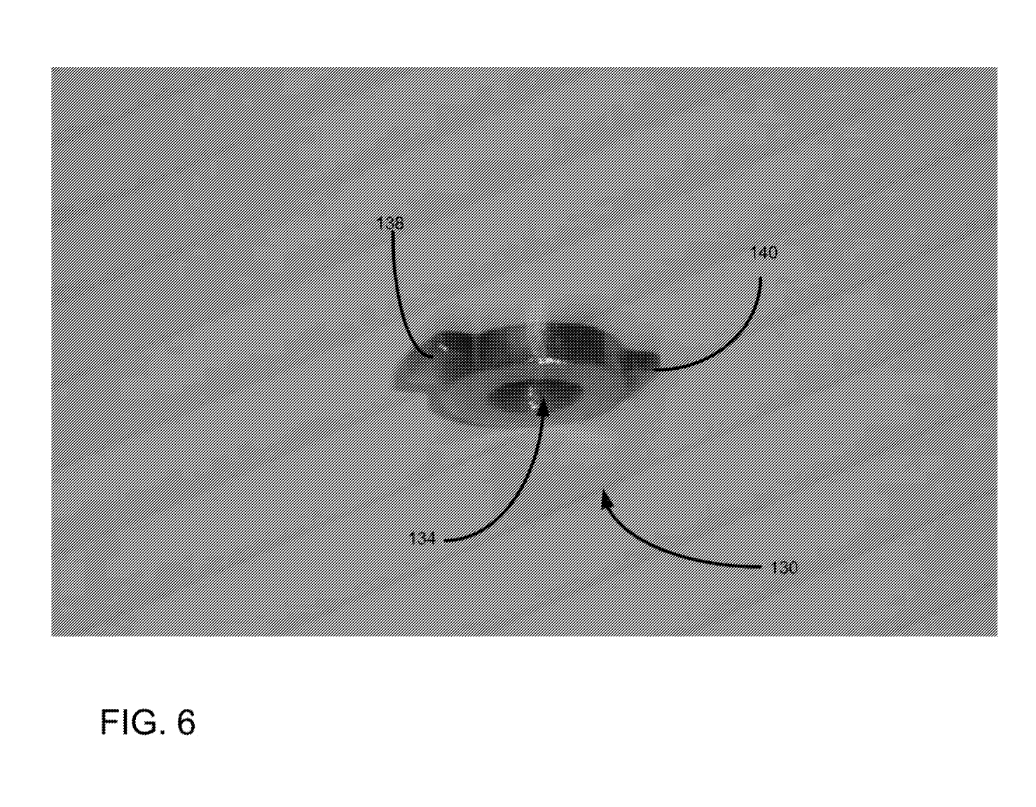

FIG. 4 is a bottom view of the cap and leads 114 and 116 removed from the wires 110 and 112. The orifice 120 includes two slots 122 and 124 matching the shape of an adapter ring 130 (see FIG. 5). FIG. 5 is a top view of the adapter ring 130. FIG. 6 is a side view of the adapter ring 130. The adapter ring 130 includes a ring portion 132, a hole 134, a threaded rim 136, and two extensions 138 and 140.

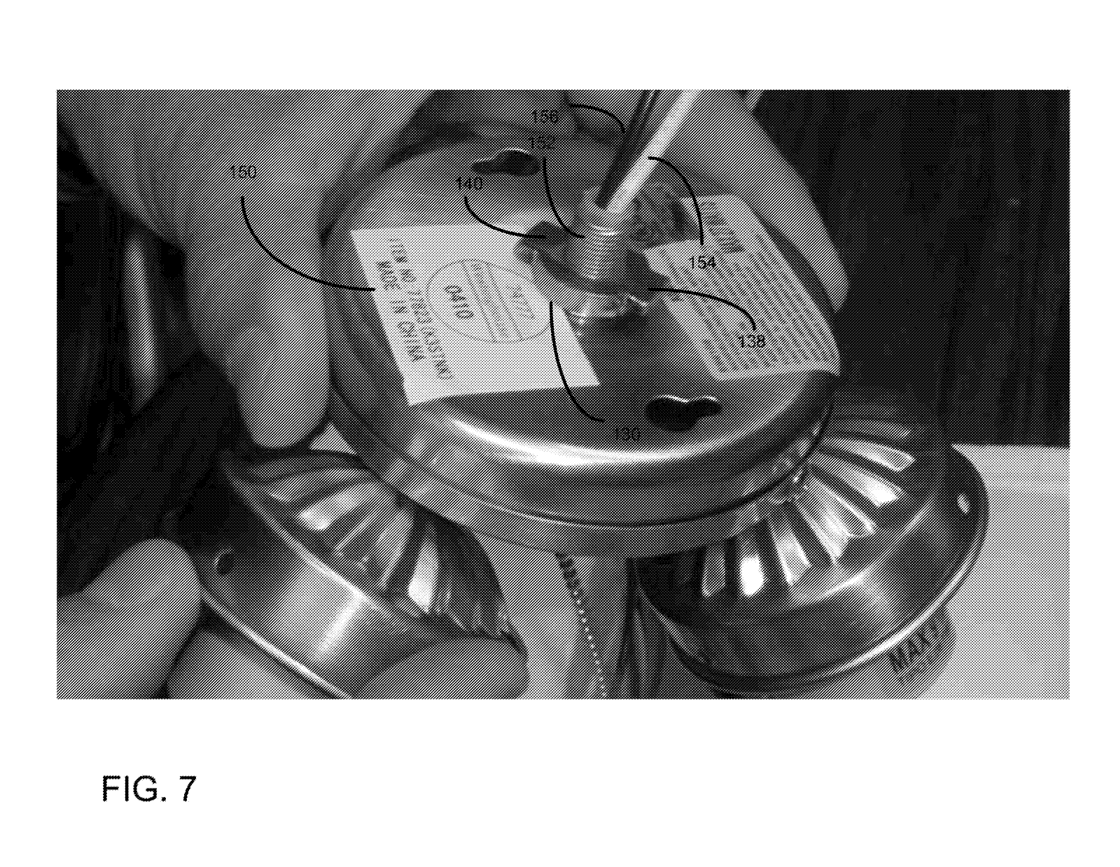

FIG. 7 is a top view of a light fixture 150. The light fixture includes a threaded shaft 152 with wires 154 and 156 threaded through a bore of the shaft. The wires lead to lights on the light fixture. The light fixture is a typical light fixture. The shaft is positioned within the hole 134 of the adapter ring and threaded onto the threaded rim 136 of the adapter ring.

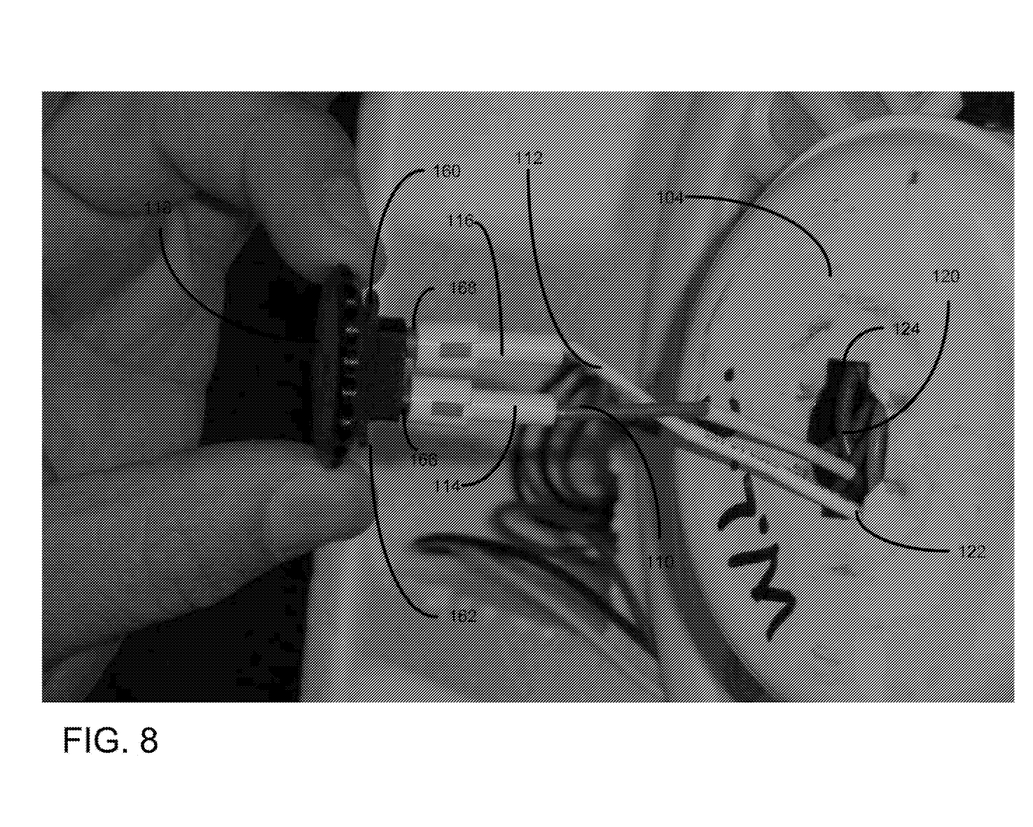

FIG. 8 is a top view of the removable cover 118 being pulled from the cap 104. The cover includes wing extensions 160 and 162 corresponding to the slots 122 and 124 of the orifice. The cover is retained within the orifice by the wing extensions. The wing extensions are rotated to align with the slots in the orifice to remove the cover. The cover includes prongs 166 and 168 which are connected to leads 114 and 116. When desired, the cover is removed from the cap by rotating the cover to align the wing extensions with the slots 122 and 124 of the orifice and pulled outwardly. The cover is attached to the wires 110 and 112, thereby pulling the wires out of the enclosure 106 without removing the cap 104 from the enclosure.

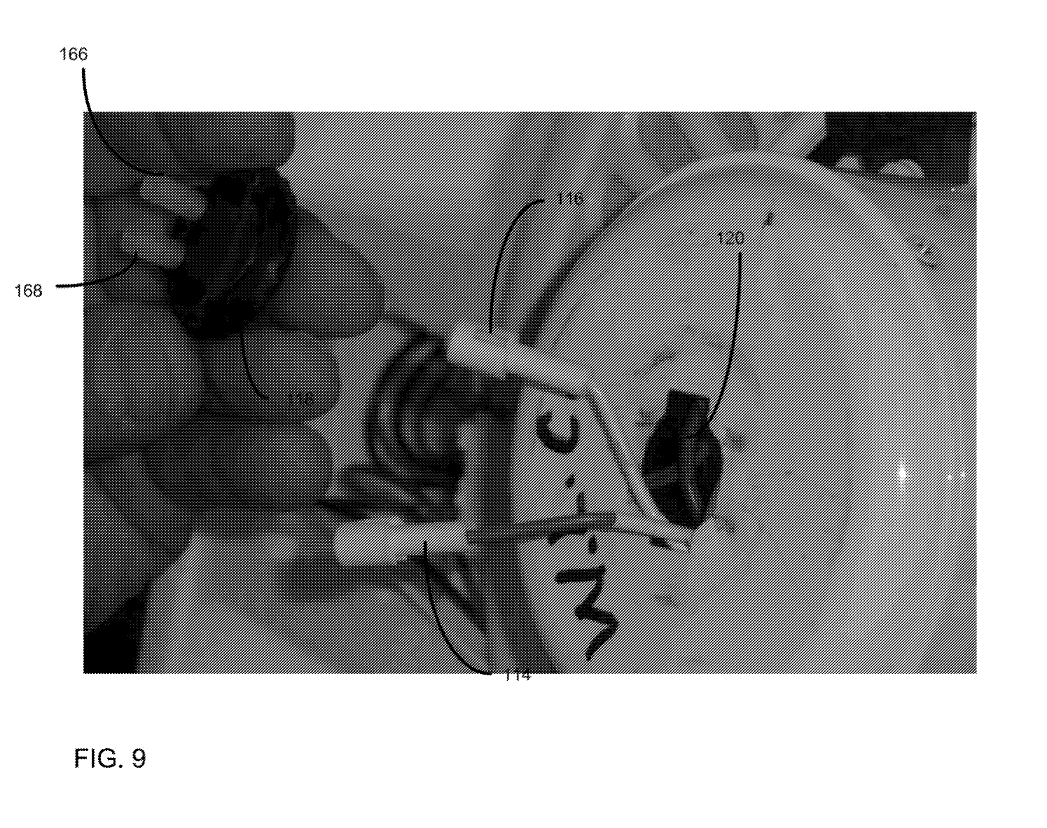

After the wires 110 and 112 are removed from the enclosure 106, the removable cover 118 is removed from the leads 114 and 116. FIG. 9 is a top view of the cap 104 illustrating the cover removed from the leads.

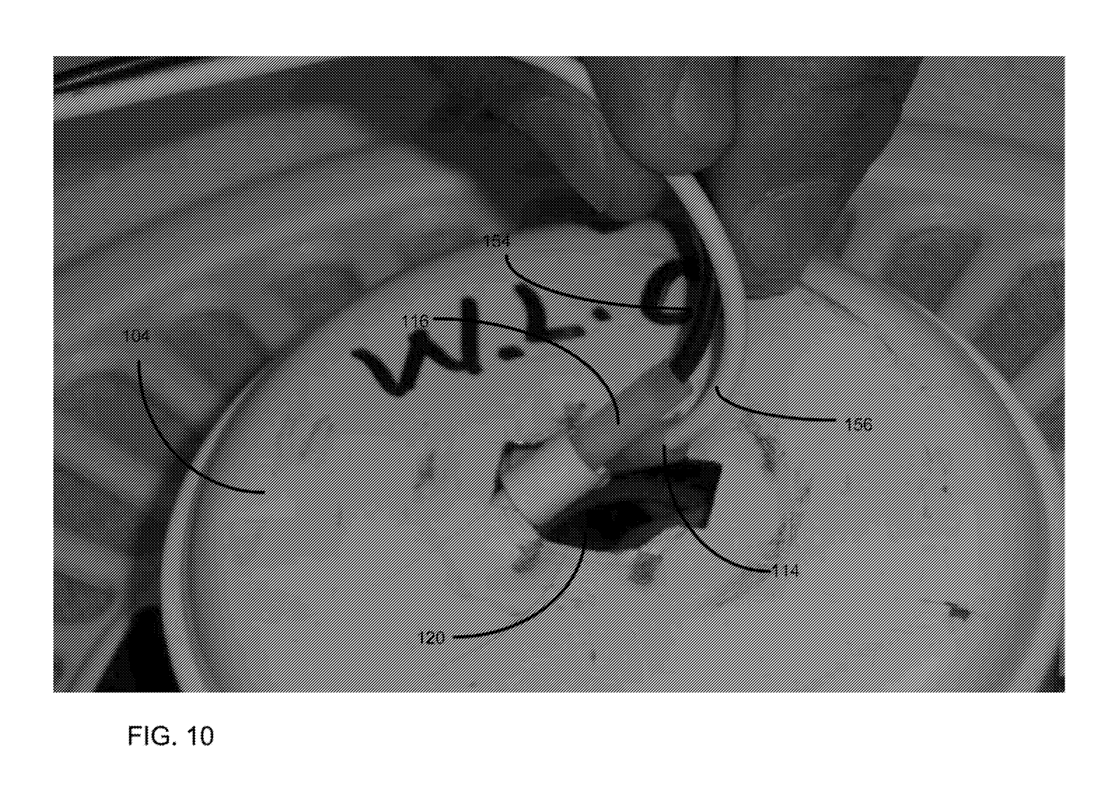

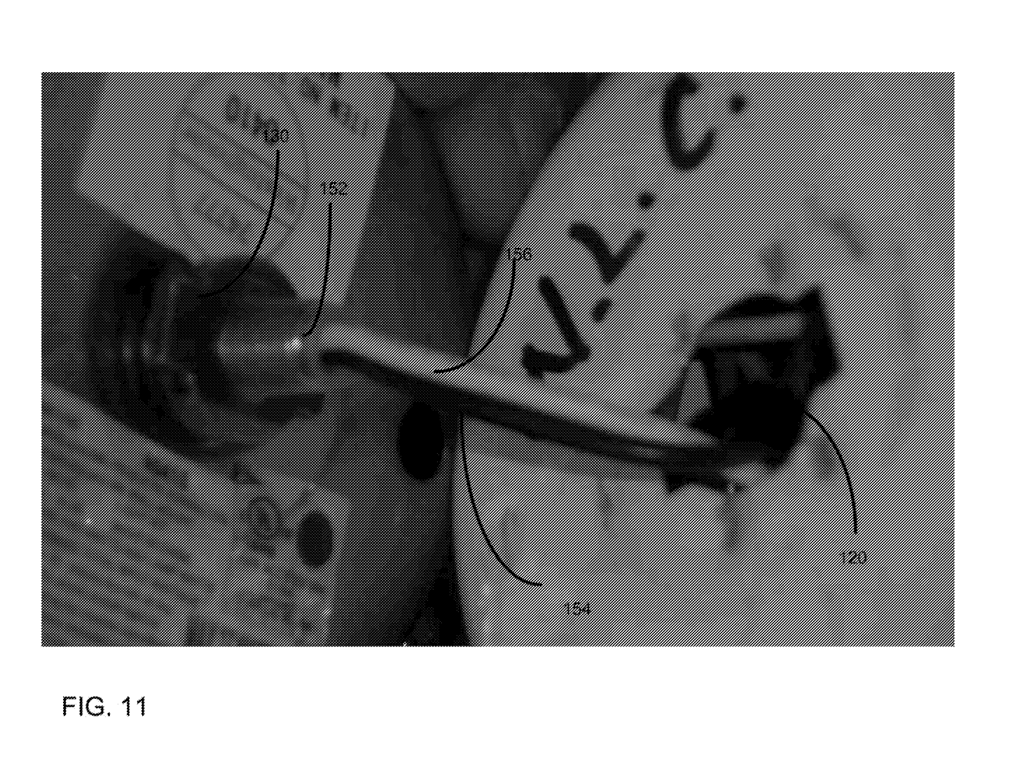

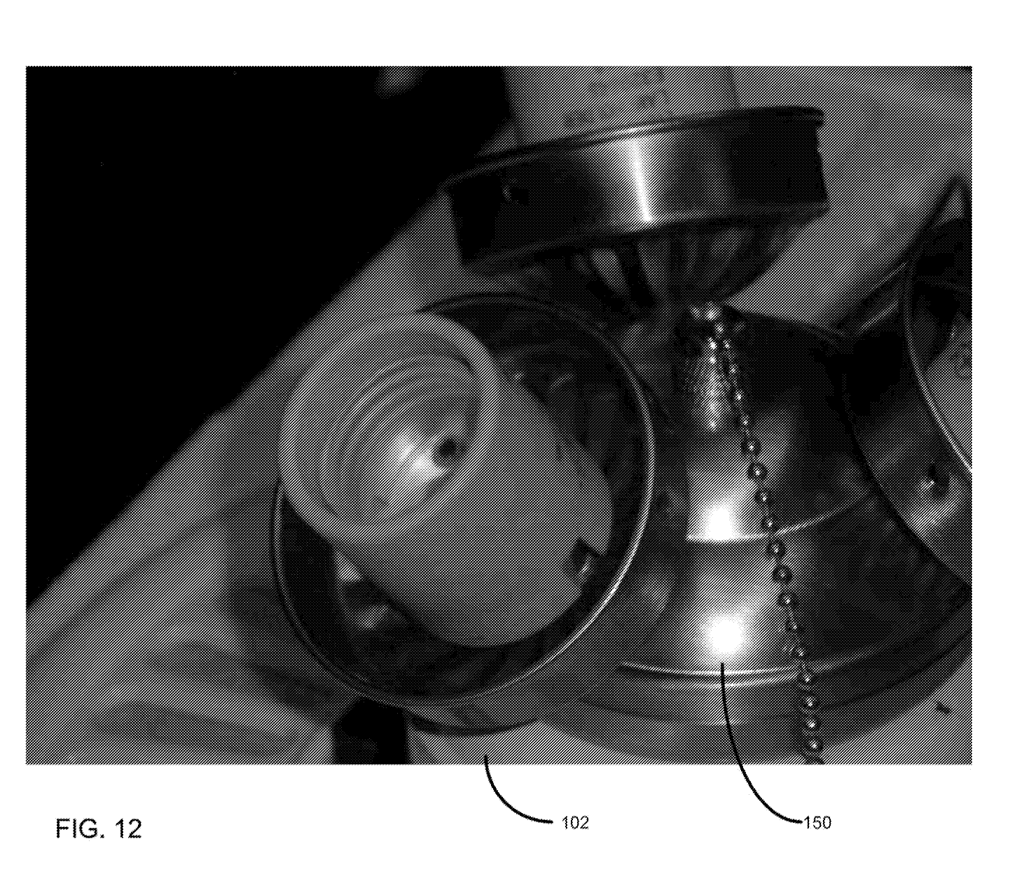

Next, the wires 154 and 156 of the light fixture 150 are connected to leads 114 and 116. FIG. 10 is a top view of the wires 154 and 156 connected to the leads 114 and 116 prior to insertion through the orifice 120. FIG. 11 is a top view showing the leads 114 and 116 being inserted in the enclosure 106. After connecting the wires 154 and 156 to the leads, the leads and wires are inserted through the orifice into the enclosure. FIG. 12 is a side view of the light fixture 150 mounted to the mounting assembly 102. After the wires 154 and 156 are inserted within the enclosure, the adapter ring is aligned in such a manner that the adapter ring extensions 138 and 140 are aligned with the orifice's slots 122 and 124. The adapter ring extensions are sized to fit through the orifice by aligning the extensions with the orifice slots. The extensions 138 and 140 are inserted through the orifice and then the adapter ring and light fixture is twisted, thereby rotating the extensions away from the slots and retaining the light fixture against the cap 104.

By utilizing the present invention, the light fixture is easily connected and mounted to the electrical box without removing the cap from the electrical box. The present invention is not limited to mounting a light fixture to an electrical box. The present invention may be utilized in an electrical device which requires attachment, with wires to another wired object. Furthermore, the adapter ring may be utilized on existing fixtures without any modification to the fixtures.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A quick connect fixture system comprising:
an electrical fixture having a plurality of fixture wires;
an electrical box affixed to a structure, the electrical box having an enclosure housing a plurality of structure wires connected to a power source;
wherein the electrical box includes a cap having an orifice leading to the structure wires located in the enclosure, the orifice having a plurality of slots;
an adapter ring attachable to a shaft of the electrical fixture, the adapter ring sized and shaped to fit within the orifice;
wherein the adapter ring includes extensions corresponding to the slots of the orifice, the extensions sized and shaped to fit through the slots when the extensions are aligned with the slots;
wherein the adapter ring, upon passing through the orifice, is retained against the cap by twisting the adapter ring to move the extensions away from the slots.

2. The system according to claim 1 further comprising a removable cover covering the orifice and having a plurality of prongs sized and shaped to be removably attached to leads of the structure wires, the removable cover sized and shaped to fit within the orifice.

3. The system according to claim 2 wherein the cover is removed from the orifice allowing the structure wires within the enclosure to be pulled through the orifice without removing a cap covering a bottom portion of the electrical box.

4. The system according to claim 1 wherein the electrical fixture is attached to the electrical box without utilizing any threaded components.

5. The system according to claim 1 wherein the adapter ring is attachable to a standard electrical fixture.

6. The system according to claim 1 wherein the electrical fixture is a light fixture.

7. The system according to claim 6 wherein the light fixture includes a threaded shaft with a bore for retaining the plurality of fixture wires.

8. The system according to claim 7 wherein the adapter ring includes a threaded rim for attachment to the threaded shaft of the light fixture.

9. The system according to claim 1 wherein the adapter ring includes two wing extensions, the wing extensions sized and shaped to fit through the slots of the orifice.

10. A quick connect fixture system comprising:
an electrical fixture having a plurality of fixture wires;
an electrical box affixed to a structure, the electrical box having an enclosure housing a plurality of structure wires connected to a power source;
wherein the electrical box includes a cap having an orifice leading to the structure wires located in the enclosure, the orifice having a plurality of slots;
an adapter ring attachable to a shaft of the electrical fixture, the adapter ring sized and shaped to fit within the orifice; and
a removable cover covering the orifice and having a plurality of prongs sized and shaped to be removably attached to leads of the structure wires, the removable cover sized and shaped to fit within the orifice;
wherein the adapter ring includes extensions corresponding to the slots of the orifice, the extensions sized and shaped to fit through the slots when the extensions are aligned with the slots;
wherein the cover is removed from the orifice allowing the structure wires within the enclosure to be pulled through the orifice without removing a cap covering a bottom portion of the electrical box;
wherein the adapter ring, upon passing through the orifice, is retained against the cap by twisting the adapter ring to move the extensions away from the slots.
